(19) United States
(12) Patent Application Publication
(10) Pub. No.: US 2025/0100922 A1
(43) Pub. Date: Mar. 27, 2025

(54) ENAMEL PASTE COMPOSITIONS AND METHODS OF FORMING ENAMEL COATINGS USING SAID COMPOSITIONS

(71) Applicant: FENZI AGT NETHERLANDS B.V., Maastricht (NL)

(72) Inventors: Simon F. BARTOLOMEY, Maastricht (NL); Simon JOHNSON, Maastricht (NL); Roland KATZBACH, Maastricht (NL); Albert J.B. LOMAN, Maastricht (NL); Philippe Germain Robert MARQUET, Maastricht (NL); Patricia Ann SUTTON, Maastricht (NL)

(21) Appl. No.: 18/727,270

(22) PCT Filed: Jan. 5, 2023
(86) PCT No.: PCT/NL2023/050003

§ 371 Date: Jul. 8, 2024

(30) Foreign Application Priority Data
Jan. 7, 2022 (GB) 2200139.0

(51) Int. Cl. C03C 8/16; C03C 3/062; C03C 3/066; C03C 3/14; C03C 8/04; C03C 8/06; C03C 17/04

(52) U.S. Cl. CPC C03C 8/16; C03C 3/062; C03C 3/066; C03C 3/14; C03C 8/04; C03C 8/06; C03C 17/04; C03C 2207/00; C03C 2217/28; C03C 2217/475

(57) ABSTRACT

An enamel paste composition includes: glass frit; a pigment; an organic carrier medium; and an oxygen source material to facilitate clean removal of the organic carrier medium components during firing, wherein the oxygen source material includes a combination of: (i) a first oxygen source material which releases oxygen at a temperature of less than 350° C.; and (ii) a second oxygen source material which releases oxygen at a temperature of greater than 350° C. The first oxygen source material can be magnesium peroxide and the second oxygen source material can be barium peroxide. The enamel paste composition is utilized to form enamel coated products without requiring a pre-firing step.

### FIELD

The present specification relates to enamel paste compositions, enamel coated products, and methods of manufacturing the same.

### BACKGROUND

In the automotive glazing industry, it is common to decorate windshields, back and side lights, and other glass components with a black band of obscuration enamel extending around a peripheral region of the components. A primary function is to shield the glue that holds the glass components in place from ultraviolet radiation which would otherwise decompose the glue. A secondary function is to cover up electrical circuits, wires, and connectors that ensure functionality of electrical or electronic components attached to, or embedded into, the glass component and ensure a clean aesthetic appearance.

Enamels typically comprise glass frit and pigment in an organic carrier medium. The enamels are applied as a paste or ink in a screen printing or ink jet process to a flat glass substrate and are subsequently fired at high temperatures, during which the organic carrier medium of the paste or ink burns off and the enamel fuses together and establishes a bond to the substrate. The firing process also softens the substrate which can be formed into the final shape by a bending process during the firing process.

It is conventional to utilize a multi-step firing process to form an enamel layer, the process comprising: (i) a first “pre-firing” heating step at a temperature sufficient to remove organic carrier medium components of the enamel paste, thus forming a dry, pre-fired layer; and (ii) a second “firing” heating step at a temperature above the glass transition of the glass frit in the enamel paste to fuse the enamel. During the second firing step the substrate can be formed into the final shape by a bending process.

Glass panels for automotive applications typically comprise two glass sheets united by an interlayer sheet (e.g. a polymeric film). One of the glass sheets forms the outer glass sheet of the glass panel while the other glass sheet forms the inner glass sheet. The sides of the glass sheets in a motor vehicle glass panel are conventionally numbered from the outside towards the inside. As such, the outer side of the outer glass sheet is conventionally designated side 1, the inner side of the outer glass sheet is conventionally designated side 2, the side of the inner glass sheet which faces the outer glass sheet is conventionally designated side 3, while the interior side of the inner glass sheet is conventionally designated side 4. It is typical for the enamel layer to be formed on side 2 of the outer glass sheet in such an automotive glass panel. An example of such a process is illustrated in FIG. 1. The enamel paste composition is printed onto a first glass sheet. The enamel paste is then pre-fired at a temperature over 400° C. and more typically over 500° C. A second glass sheet is then disposed over the pre-fired enamel on the first glass sheet and the stack of glass sheets is fired at a temperature over 500° C. and more typically over 600° C. to form a fired glass panel product.

In the process illustrated in FIG. 1, the pre-firing step is performed prior to the deposited enamel paste being sandwiched between the two glass sheets. This is done to remove organic components from the enamel while being exposed to an oxidizing atmosphere. If the glass sheet with printed black obscuration enamel is paired with another glass sheet and fired without pre-firing, undesired results occur. First, organic materials decompose into low molecular weight species and volatilize creating an excess pressure between the two glass sheets. Second, decomposition proceeds in oxygen-deficient conditions between the glass sheets that results in incomplete burn-off of organics. Incomplete decomposition results in formation of char, reduction of pigment, and slows down the fusion of the enamel, significantly affecting the product performance and aesthetics of the glass product.

To avoid the above problems, it is conventional in the industry to use a preliminary firing step, known as pre-firing, to burn away organics in the layer of black enamel. Pre-firing is typically conducted at temperatures as high as 500-650° C. (slightly below the softening point of the glass sheets) that is relatively similar in terms of energy consumption to actual firing. Performing both a pre-firing and a firing step significantly increases energy consumption and associated environment impact and cost. Furthermore, after pre-firing, if a cold glass sheet is placed on a hot, pre-fired glass sheet for firing this can lead to optical distortions, particularly for deeply bent laminates. Alternatively, if the pre-fired glass sheet is cooled prior to pairing with the second glass sheet then this is also highly energy demanding, time consuming, and costly.

EP1888333 proposes a method of making a decorated multilayer glass structure using a single firing step that includes that use of a crystallizing glass enamel composition that contains ingredients to ensure the burnout of the organic portion of the composition upon firing and bending of a mated pair of glass sheets. It is described that when applied to one sheet of a mated pair of glass sheets, the organic portion of the composition burns out during firing and bending of the pair. The presence of oxidizers in the composition ensures a supply of oxygen to enable combustion of the organic vehicle while firing the glass sheets and prior to the sintering of the enamel composition to only one glass sheet in a mated pair of decorated or coloured glass sheets.

The composition described in EP1888333 comprises: 20-80 wt % of a reactive glass component; 0.01-7 wt % of an oxidizer component; 10-40% of a pigment; 10-40 wt % of an organic vehicle; and 1-20 wt % of a seed material. The oxidizer component comprises an oxidizer selected from the group consisting of ammonium nitrate, antimony pentoxide, barium nitrate, bismuth pentoxide, bismuth subnitrate, bismuth tetroxide, calcium nitrate, calcium peroxide, cesium nitrate, cobalt nitrate, copper nitrate, lithium nitrate, magnesium peroxide, manganese dioxide, nickel (III) oxide, platinum monoxide, platinum dioxide, potassium nitrate, potassium peroxide, sodium nitrate, sodium percarbonate, sodium peroxide, strontium nitrate, strontium peroxide, silver nitrate, tellurium trioxide, tin nitrate, and zinc peroxide and combinations thereof. The seed material contains at least one phase selected from the group consisting of Zn₂SiO₄, Bi₁₂SiO₂₀, Bi₄(SiO₄)₃, Bi₂SiO₅, 2ZnO*3TiO₂, Bi₂O₃*SiO₂, B₁₂O₃*2TiO₂, 2B₁₂O₃*3TiO₂, Bi₂Ti₄NbO₂₁, Bi₄Ti₃O₂₁, Bi₄Ti₃O₁₂, Bi₂TiO₂O₇, Bi₂TiO₂₀, Bi₄Ti₃O₁₂, and Bi₂Ti₄O₁₁.

The enamel composition is applied to a first glass substrate and a second glass substrate is then stacked with the first glass substrate, wherein the green crystallizing enamel composition lies between the first and second glass substrates. The stacked glass substrates are then subjected to a firing operation whereby the green crystallizing enamel fuses to the first glass substrate, the organic vehicle burns out completely, and the glass substrates do not stick to one another.

While the aforementioned publication describes an enamel composition adapted for use in a method which does not require a pre-firing step, there is still a need to provide improved enamel paste formulations for use in such methods and which provide clean burn-out during firing while also resulting in an enamel with consistently good optical/colour properties as well as other desirable characteristics such as silver hiding/blocking performance, low optical distortion, and/or mechanical stability. It is an aim of the present specification to address this need.

### SUMMARY

According to an aspect of the present specification there is provided an enamel paste composition comprising: glass frit; a pigment; an organic carrier medium; and an oxygen source material to facilitate clean removal of the organic carrier medium components during firing, wherein the oxygen source material comprises a combination of: (i) a first oxygen source material which releases oxygen at a temperature of less than 350° C. (i.e. releases some or all of its oxygen content below 350° C.); and (ii) a second oxygen source material (different from the first oxygen source material) which releases oxygen at a temperature of greater than 350° C.

Optionally, the first oxygen source material releases oxygen at a temperature of less than 330° C., less than 300° C., less than 280° C., less than 260° C., or around 250° C. (preferably at a temperature greater than 100° C.). Furthermore, optionally the second oxygen source material releases oxygen at a temperature of greater than 370° C., greater than 400° C., greater than 420° C., greater than 440° C., or around 450° C. (preferably at a temperature less than 800° C.). The first and second oxygen source materials may comprise or consist of peroxide materials. The first oxygen source material may comprise or consist of magnesium peroxide or calcium peroxide, preferably magnesium peroxide. The second oxygen source material may comprise or consist of barium peroxide, barium oxide, a barium oxide containing glass frit, or strontium peroxide, preferably barium peroxide.

While not being bound by theory, when using barium peroxide as the second oxygen source material it is believed that in the temperature range of 350 to 450° C. barium peroxide starts to decompose to barium oxide and oxygen resulting in an equilibrium where barium oxide recombines with atmospheric oxygen to barium peroxide. With increasing temperature, the equilibrium is continuously shifted towards the product side until around 750° C. no back reaction takes place anymore.

$$2 Ba {O}_{2} ↔ 2 Ba O + {O}_{2}$$

As this equilibrium starts at relatively low temperatures and persists over a wide temperature range it acts as oxygen buffer ensuring the matching of oxygen release and thermal degradation of the organic components in the process.

By providing at least two different oxygen release materials with significantly different oxygen release temperatures, oxygen is released over a broader temperature window during application of the firing profile resulting in a better burn-off for the organics and leading to better optical, mechanical, and/or chemical characteristics of the enamel coating when using a single firing step (without a pre-firing step). That is, the use such a combination of oxygen release materials is advantageous in achieving clean burn-out during firing while also resulting in an enamel with consistently good optical/colour properties (e.g. a better L-value) as well as other desirable characteristics such good as silver hiding/blocking performance, low optical distortion, and high mechanical and chemical stability. The broad temperature range for oxygen release also increases the robustness of the firing process and allows a greater degree of flexibility for the firing profile.

The use of barium peroxide as an oxygen release material has been found to be particularly advantageous in achieving good enamel characteristics when using a firing methodology which does not include pre-firing. As such, in accordance with another aspect of the present specification there is provided an enamel paste composition comprising: glass frit; a pigment; an organic carrier medium; and an oxygen source material to facilitate clean removal of the organic carrier medium components during firing, wherein the oxygen source material comprises barium peroxide. As described in relation to the previous aspect, the barium peroxide is optionally/advantageously provided in combination with one or more further oxygen release materials, e.g. another peroxide material such as magnesium peroxide and/or another material which releases oxygen at a lower temperature than barium peroxide during firing of the enamel paste.

The present specification also provides a method of forming an enamel coating, the method comprising: depositing the enamel paste composition on a substrate; drying the deposited enamel paste composition at a temperature under 400° C.; and firing the dried enamel paste to form an enamel coating on the substrate without pre-firing at a temperature over 400° C. (e.g. between 400° C. and 800° C.). Such a method does not require a pre-firing step and the drying may be performed at a temperature below 350° C., 300° C., 250° C., 200° C., or 175° C., e.g. around 150° C. (optionally greater than 100° C.). Advantageously, the method can be applied to construct a glass panel comprising two substrates as previously discussed. In this case, after drying, a second substrate is disposed over the dried enamel prior to firing such that the enamel coating is formed between the substrates.

### BRIEF DESCRIPTION OF THE DRAWINGS

For a better understanding of the present invention and to show how the same may be carried into effect, certain embodiments of the present invention will now be described by way of example only with reference to the accompanying drawings, in which:

FIG. 1 shows a schematic illustration of a method of fabricating a glass panel comprising both pre-firing and firing steps;

FIG. 2 shows a schematic illustration of a method of fabricating a glass panel which does not require a pre-firing step;

FIG. 3 shows a picture of a glass panel fabricated using a prior art enamel paste formulation and a method which does not include a pre-firing step; and

FIG. 4 shows two pictures of a glass panel fabricated using an enamel paste formulation according to the present specification and a method which does not include a pre-firing step.

### DETAILED DESCRIPTION

As described in the summary section, the present specification is directed to enamel paste compositions which do not require pre-firing. In this regard, it is conventional to utilize a method which includes both a pre-firing step and a firing step as shown in FIG. 1 and described in the background section. In such a method, energy costs of pre-firing are similar to the costs of firing and cold glass on hot pre-fired glass can cause optical distortion for deeply bent laminates.

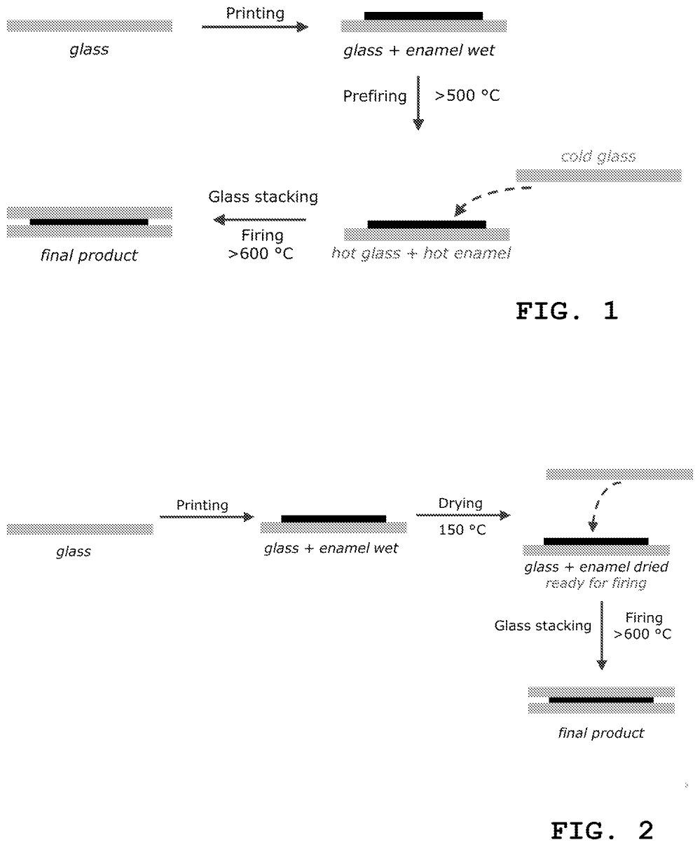

In contrast, the enamel paste compositions of the present specification are designed for methods such as that illustrated in FIG. 2. In such methods, the enamel paste is printed onto a first glass sheet and dried at a temperature around 150° C. without pre-firing at higher temperatures in excess of 400° C. or 500° C. A second glass sheet is disposed over the dried enamel coating and the stack of glass sheets is then fired in a single step. Key benefits include: reduced energy, cost, and environmental impact by elimination of the pre-firing step; increased manufacturing throughput (e.g. by using pre-firing furnaces for actual firing); reduction in manufacturing footprint/capex (less furnaces required); minimized optical distortion issues as the two glass sheets are fired simultaneously without pre-firing either sheet.

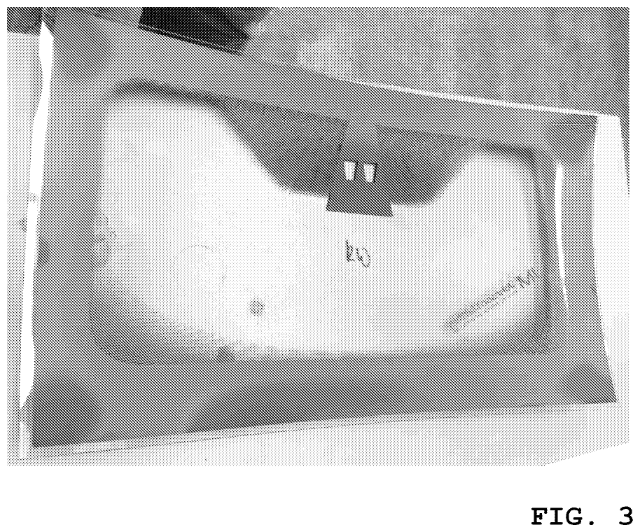

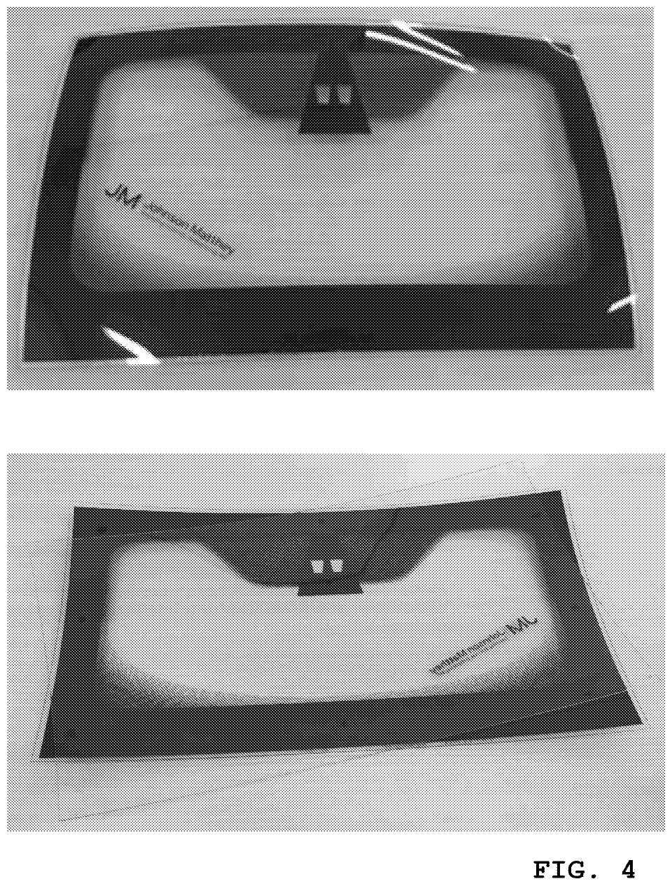

As described earlier in this specification, if such a method is utilized with a conventional enamel paste organic materials in the enamel paste decompose into low molecular weight species and volatilize during firing creating an excess pressure between the glass two sheets. Furthermore, decomposition proceeds in oxygen-deficient conditions that results in incomplete burn-off of organics. Incomplete decomposition results in formation of char, reduction of pigment, and slows down the fusion of the enamel significantly affecting the product performance and aesthetics of the glass product. FIG. 3 shows a picture of a glass panel fabricated using a prior art enamel paste formulation and a method which does not include a pre-firing step. A number of problems occur as a result of the none-clean burn-out of organics including: inhomogeneous colour development; high porosity enamel; adhesion of glass sheets to each other; transfer of enamel from one glass sheet to the other.

As described in the summary section, it has been found that the use of an oxygen source material which comprises a combination of a first oxygen source material which releases oxygen at a temperature of less than 350° C. (e.g. magnesium peroxide) and a second oxygen source material which releases oxygen at a temperature of greater than 350° C. (e.g. barium peroxide), is advantageous in achieving clean burn-out during firing while also resulting in an enamel with consistently good optical/colour properties as well as other desirable characteristics such as low porosity and good silver hiding/blocking performance, low optical distortion; good non-stick properties; and high mechanical and chemical stability.

As also described in the summary section, the use of barium peroxide as an oxygen release material has been found to be particularly advantageous in achieving good enamel characteristics when using a firing methodology which does not include pre-firing. As such, enamel paste compositions according to the present specification comprise at least barium peroxide as an oxygen release material (e.g. 4 to 15 wt % barium peroxide). Optionally, the barium oxide could be utilized alone, although advantageously the paste also comprises one or more further oxygen release materials, e.g. another peroxide material such as magnesium peroxide.

The enamel paste composition may comprise: more than 4 wt %, 5 wt %, 6 wt %, 7 wt %, 7.5 wt %, 8 wt %, 9 wt %, or 10 wt % of the oxygen source material in total, including both the first and second oxygen source materials; no more than 30 wt %, 20 wts, or 15 wt % of the oxygen source material in total; or a total oxygen source material content within a range defined by any combination of the aforementioned lower and upper limits.

Advantageously, the enamel paste composition may comprise: at least 2 wt %, 3 wt %, 4 wt %, 5 wt %, or 6 wt % barium peroxide; no more than 15 wt %, 12 wt %, 10 wt %, 8 wt %, or 7 wt % barium peroxide; or a barium peroxide content within a range defined by any combination of the aforementioned lower and upper limits. Advantageously the barium oxide is provided as the second, higher temperature oxygen release material in combination with a first, lower temperature oxygen release material.

The first, lower temperature oxygen release material may be a solid powdered complex of magnesium peroxide and magnesium oxide, MgO₂·xMgO. An example of such an oxygen source material is IXPER® 30 MG from Solvay. The material is marketed for soil treatment but has been found to be extremely effective as an additive for enamel paste formulations as described herein. The material comprises a stable complex of magnesium peroxide and magnesium oxide in solid powdered form and functions to provide a consistent and reliable release of oxygen within an enamel paste formulation during the early stages of firing in a temperature range of 250-400° C. The material facilitates a very clean burn-off of organics in oxygen deficient conditions during firing of the enamel paste formulation, achieving consistently good optical characteristics for the resultant enamel without requiring a pre-firing step. Furthermore, a relatively low amount of such a material is required to achieve such desirable results. For example, the enamel paste may comprise between 3% and 15% by weight of this oxygen source material, and optionally less than 10% by weight of the oxygen source material.

Advantageously, the enamel paste compositions according to the present specification comprises a low level of seed material or no seed material. For example, the enamel paste composition may comprise: less than 1 wt %, 0.8 wt %, 0.6 wt %, 0.4 wt %, 0.2 wt %, or 0.1 wt % of a seed material; more than 0 wt %, 0.01 wt %, or 0.05 wt %; or a seed content within a range defined by any combination of the aforementioned upper and lower limits. The seed material may comprise or consist of a crystalline bismuth silicate seed powder (e.g. Eulytite). The seed promotes crystallization to facilitate non-stick performance and eliminate enamel transfer. It has been found that paste formulations as described herein do not require a large amount of seed material.

Optionally the enamel paste comprises between 40% and 70% by weight of the glass frit. The glass frit may comprise a mixture of vitreous glass frit (e.g. a bismuth-boron-zinc glass system) and crystallizing glass frit (e.g. a bismuth-silicon glass system or a combination of such systems). The enamel paste composition may comprise, for example, between 40% and 60% by weight of the vitreous glass frit and between 5% and 15% by weight of the crystallizing glass frit. The crystallizing glass frit may have a particle size distribution with a D90 between 15 and 25 micrometres and a D50 between 7 and 13 micrometres. Alternatively, the crystallizing glass frit may be bead milled to a lower particle size, e.g. having a D90<4 micrometres. It has been found that providing such a combination of glass frits with the oxygen source material can improve the optical characteristics of the resultant enamel when fired using a single firing step.

The enamel paste composition may comprise between 15% and 30% by weight of the pigment. The pigment may comprise or consist of a Cu—Mn—Cr pigment.

Furthermore, the enamel paste may comprise between 7% and 15% by weight of the organic carrier medium. The organic carrier medium may include one, more, or all of a wetting and dispersant agent, a binder, a solvent, and an organic additive.

The method of the present specification involves forming an enamel coating, the method comprising: depositing the enamel paste composition according to any preceding claim on a substrate; drying the deposited enamel paste composition at a temperature under 400° C., 350° C., 300° C., 250° C., 200° C., or 175° C.; and firing the dried enamel paste at a temperature over 400° C., 450° C., or 500° C. to form an enamel coating on the substrate without pre-firing. After drying, a second substrate can be disposed over the dried enamel prior to firing such that the enamel coating is formed between the substrates.

FIG. 4 shows two pictures of a glass panel fabricated using an enamel paste formulation according to the present specification and a method as described above which does not include a pre-firing step. The top picture is a view from the outside of the glass windscreen panel showing good colour development, the enamel being homogenous and dark in colour. The bottom picture is a view from the interior side of paired glass sheets fired together. The glass sheets have been offset to show good non-stick properties (easy to unpair and process), no enamel transfer (top glass is clean), and homogeneous and clean burn-out (no yellow discoloration).

Examples of two enamel paste compositions according to the present specification are summarized in the below table:

| | Example 1 | Example 2 |
|---|---|---|
| | wt % | wt % |
| Glass frit (Bi—B—Zn | 48.58 | 45.25 |
| system) | | |
| Glass frit (Bi—Si | 5.76 | — |
| system 1) | | |
| Glass frit (Bi—Si | — | 3.56 |
| system 2) | | |
| Glass frit (Bi—Si | — | 7.10 |
| system 3) | | |
| Eulytite seed powder = | — | 0.09 |
| Bi₄(SiO₄)₃ | | |
| Pigment (Cu—Mn—Cr | 20.73 | 24.00 |
| system) | | |
| Magnesium peroxide | 6.91 | 4.45 |
| Barium peroxide | 6.90 | 4.44 |
| Organic vehicle | 11.12 | 11.12 |
| (medium) | | |

The glass frit compositions for the example pastes given above are provided in the below tables:

Bi—B—Zn Glass Frit System

| Component | Mass % |
|---|---|
| B₂O₃ | 10-15 |
| ZnO | 10-15 |
| Bi₂O₃ | 55-70 |
| SnO₂ | 5-15 |
| SiO₂ | 0-5 |
| Al₂O₃ | 0-5 |

Bi—Si Glass Frit Systems 1 & 2

| Component | Mass % |
|---|---|
| SiO₂ | 25-35 |
| Bi₂O₃ | 55-65 |
| Li₂O | 0-5 |
| B₂O₃ | 0-5 |
| Na₂O | 0-5 |
| ZnO | 0-5 |
| F | 0-3 |
| Al₂O₃ | 0-3 |
| CuO | 0-3 |
| MnO | 0-3 |
| Fe₂O₃* | 0-1 |

Bi—Si Glass Frit System 3

| Component | Mass % |
|---|---|
| SiO₂ | 25-35 |
| Bi₂O₃ | 45-60 |
| Li₂O | 0-5 |
| B₂O₃ | 0-3 |
| TiO₂ | 0-5 |
| Na₂O | 0-5 |
| K₂O | 0-5 |
| Al₂O₃ | 0-5 |
| Fe₂O₃* | 0-1 |

*Fe₂O₃ is impurity that comes with the other raw materials.

In addition to modifying the solid content of the enamel paste composition to achieve the desired functional performance, the composition of the organic carrier medium (organic vehicle) can also be modified to improve performance of the paste and facilitate clean burn-out in a single-firing step methodology.

The organic vehicle is designed to provide excellent printability, rheological stability, and clean burn-off in the presence of an oxygen source without using pre-firing. In this regard, a mixture of solvents, dispersant, and polymer components can be used to tune printability and rheological stability. In accordance with the present specification, a low decomposition point polymer such as a poly-butylacrylate or an iso-butyl methacrylate polymer can be utilized to facilitate clean burn-off while maintaining good printability and rheological stability. An example of a suitable organic carrier medium (organic vehicle) composition is summarized in the below table:

| Component | Content (wt %) |
|---|---|
| Dispersant | 7.19 |
| Low decomposition point polymer (e.g. | 6.19 |
| iso-butyl methacrylate polymer) | |
| Solvent 1 (e.g. ester alcohol) | 72.23 |
| Solvent 2 (e.g. branched primary | 14.39 |
| alcohol) | |

An enamel paste composition as described above exhibits a number of advantageous features when used in a method which does not involve pre-firing including:
good glass to enamel non-stick performance;
good optical properties (L-value <5);
good black colour (−1<a<1 and −1<b<1);
good printability and stability; and
compatible with existing laminating processes.

Accordingly, the present specification provides enhanced black enamel pastes that do not require pre-firing. The pastes facilitate clean burn-off of organics in oxygen deficient conditions. Utilization of such paste compositions and methods enable automotive glass manufacturers to reduce energy consumption/cost by 40-50%, increase throughput, and increase production yield. The only heating step prior to firing is to dry the enamel after printing. Drying can be performed in infrared belt furnaces. The method can also lead to a simplification of manufacturing lines and equipment used in glass production.

While this invention has been particularly shown and described with reference to certain examples, it will be understood to those skilled in the art that various changes in form and detail may be made without departing from the scope of the invention as defined by the appended claims.

1. An enamel paste composition comprising:
glass frit;
a pigment;
an organic carrier medium; and
an oxygen source material to facilitate clean removal of the organic carrier medium components during firing, wherein the oxygen source material comprises a combination of: (i) a first oxygen source material which releases oxygen at a temperature of less than 350° C.; and (ii) a second oxygen source material which releases oxygen at a temperature of greater than 350° C.

2. The enamel paste composition according to claim 1, wherein the first oxygen source material releases oxygen at a temperature of less than 330° C. less than 300° C., less than 280° C., less than 260° C., or around 250° C.

3. The enamel paste composition according to claim 1, wherein the second oxygen source material releases oxygen at a temperature of greater than 370° C., greater than 400° C., greater than 420° C., greater than 440° C., or around 450° C.

4. The enamel paste composition according to claim 1, wherein the first oxygen source material comprises or consists of magnesium peroxide or calcium peroxide, preferably magnesium peroxide.

5. The enamel paste composition according to claim 1, wherein the second oxygen source material comprises or consists of barium peroxide, barium oxide, a barium oxide containing glass frit, or strontium peroxide, preferably barium peroxide.

6. The enamel paste composition according to claim 1, wherein the enamel paste composition comprises more than 7 wt % of the oxygen source material in total, including both the first and second oxygen source materials.

7. The enamel paste composition according to claim 6, wherein the enamel paste composition comprises more than 7.5 wt %, 8 wt %, 9 wt %, or 10 wt % of the oxygen source material in total.

8. The enamel paste composition according to claim 6, wherein the enamel paste composition comprises no more than 30 wt %, 20 wt %, or 15 wt % of the oxygen source material in total.

9. The enamel paste composition according to claim 1, wherein the enamel paste composition comprises less than 1 wt % of a seed material.

10. The enamel paste composition according to claim 9, wherein the enamel paste composition comprises less than 0.8 wt %, 0.6 wt %, 0.4 wt %, 0.2 wt %, or 0.1 wt % of the seed material.

11. The enamel paste composition according to claim 9, wherein the enamel paste composition comprises no seed material or a seed material content of greater than zero but less than 1 wt %.

12. The enamel paste composition according to claim 9, wherein the seed material comprises or consists of a crystalline bismuth silicate seed powder.

13. The enamel paste composition according to claim 1, wherein the enamel paste comprises between 40% and 70% by weight of the glass frit.

14. The enamel paste composition according to claim 1, wherein the glass frit comprises a mixture of vitreous glass frit and crystallizing glass frit.

15. The enamel paste composition according to claim 14, wherein the enamel paste composition comprises between 40% and 60% by weight of the vitreous glass frit and between 5% and 15% by weight of the crystallizing glass frit.

16. The enamel paste composition according to claim 14, wherein the vitreous glass frit comprises or consists of a bismuth-boron-zinc glass system and the crystallizing glass frit comprises or consists of a bismuth-silicate glass system.

17. The enamel paste composition according to claim 1, wherein the enamel paste composition comprises between 15% and 30% by weight of the pigment.

18. The enamel paste composition according to claim 1, wherein the enamel paste comprises between 7% and 15% by weight of the organic carrier medium.

19. A method of forming an enamel coating, the method comprising:
depositing the enamel paste composition according to claim 1 on a substrate;
drying the deposited enamel paste composition at a temperature under 400° C.; and
firing the dried enamel paste at a temperature over 400° C. to form an enamel coating on the substrate without pre-firing.

20. The method according to claim 19, wherein the enamel paste composition is dried at a temperature below 350° C., 300° C., 250° C., 200° C., or 175° C.

21. The method according to claim 19, wherein, after drying, a second substrate is disposed over the dried enamel prior to firing such that the enamel coating is formed between the substrates.
